(19) United States
(12) Patent Application Publication
(10) Pub. No.: US 2017/0261461 A1
(43) Pub. Date: Sep. 14, 2017

(54) Polymeric electrode films

(71) Applicant: pHase2 Microtechnologies Inc., Pittsburgh, PA (US)

(72) Inventors: Valeriya Bychkova, Pittsburgh, PA (US); Timothy J. Syciarz, Pittsburgh, PA (US); Yuejun Zhao, Allison Park, PA (US); James A. Spearot, Breckenridge, CO (US)

(21) Appl. No.: 15/523,386

(22) PCT Filed: Oct. 29, 2015
(86) PCT No.: PCT/US15/58132

§ 371 Date: Apr. 29, 2017

Related U.S. Application Data
(60) Provisional application No. 62/072,405, filed on Oct. 29, 2014.

(51) Int. Cl. G01N 27/30

(52) U.S. Cl. CPC G01N 27/302; G01N 27/301

(57) ABSTRACT

This application describes microelectronic pH sensors that can include indicating electrodes having a substrate, an electrode disposed on the substrate, a reactive layer disposed on a portion of the electrode, and a conductive layer disposed on the reactive material and reference electrodes having similar architecture.

### CROSS REFERENCE TO RELATED APPLICATIONS

This application claims the benefit of co-pending U.S. Provisional No. 62/072,405, entitled “POLYMER COATED METAL ELECTRODES,” filed on Oct. 29, 2014, the entire disclosure of which is hereby incorporated by reference in its entirety.

### BACKGROUND

A typical pH sensor based on potentiometric principles includes a reference solution, an indicating electrode immersed in or in contact with an analyte solution (of which the pH is to be measured), a reference electrode immersed in the reference solution, and measurement circuitry such as potentiometric circuitry in electrical connection with the reference electrode and the indicating electrode. The potentiometric circuitry measures the electrical difference between the indicating and reference electrodes. Ionic contact between the electrolyte solutions in which the indicating electrode and the reference electrodes are immersed provides electrical connection between the electrodes. The pH value of the sample or analyte electrolyte solution (which is proportional to concentration of the hydrogen ions in the sample electrolyte) is directly correlated with the potential difference developed at the indicating electrode following the Nernst equation.

One factor which affects the useful life of a pH sensor, such as a microscale pH sensor, is the durability of the electrodes. In many instances, the conductive material of the reference electrode is gradually dissolved and consumed into the saturated reference electrolyte solution. At some point during the dissolution and consumption of the reference electrode, the useful life of the pH sensor is terminated. Similarly, the conductive material of the indicating electrode may dissolve and be consumed as it comes in contact with acidic or base analytes.

Accordingly, there is a need for methods and apparatus that improve the selectivity and durability of pH sensor electrodes.

### SUMMARY

Embodiments of the present invention relate to methods and apparatus for extending the useful life of a pH sensor. In particular, the sensing areas of the electrodes are covered with polymeric films that retard the degradation of the electrodes from contact with, e.g., reference solution or analyte, while still permitting the electrical current flow necessary for the operation of the sensor.

In one aspect, embodiments of the present invention relate to a microelectronic pH sensor having an indicating electrode. In some embodiments, the indicating electrode comprises a metal/metal oxide sensing area in contact with an electrical contact and surrounded by a passivation layer. In some embodiments, the indicating electrode comprises a protective polymeric film in direct contact with and covering the metal/metal oxide sensing area.

In some embodiments, the metal/metal oxide sensing area is Ir/IrOx, Pt/PtOx, or Sb/SbOx. In some embodiments, the protective polymeric film is a conductive polymer selected from the group consisting of polyphenols, polyanilines, poly(p-phenylene sulfide), polycarbazoles, polyindoles, and polythiophenes. In some embodiments, the protective polymer film is a proton-conducting electrolyte membrane selected from the group consisting of PFSA membranes, sulfonated polymer membranes, acid-base polymer complexes, and ionic liquid-based gel-type proton conducting membranes.

In another aspect, embodiments of the present invention relate to a microelectronic pH sensor having a reference electrode. In some embodiments, the reference electrode includes a sensing area in contact with an electrical contact and surrounded by a passivation layer. In some embodiments, the reference electrode includes an electrical potential controlling polymeric film in direct contact with and covering the sensing area.

In some embodiments, the sensing area comprises Au metal or a metal/metal oxide combination selected from the group consisting of Ir/IrOx, Rh/RhOx and Pt/PtOx. In some embodiments, the polymeric film includes a hydrogel, a conducting polymer, or an electrolyte membrane. In some embodiments, the polymeric film contains encapsulated buffering ligand or injected buffer solution/gel. In some embodiments, the polymeric film is a hydrogel or an electrolyte membrane, and at least part of the polymeric film is saturated with redox species. In some embodiments, the polymeric film is an electrolyte membrane or hydrogel, and the interface between the polymeric film and the protective polymer is modified with surfactants.

In some embodiments, the electrode further includes a protective polymer in contact with and covering the polymeric film. In some embodiments, the protective polymeric film is a liquid junction polymer selected from the group of polytetrafluoroethylene, polyurethane, polyester, polyacrylate, polycyanoacrylate, and polyvinyl chloride.

These and other features and advantages, which characterize the present non-limiting embodiments, will be apparent from a reading of the following detailed description and a review of the associated drawings. It is to be understood that both the foregoing general description and the following detailed description are explanatory only and are not restrictive of the non-limiting embodiments as claimed.

### BRIEF DESCRIPTION OF THE DRAWINGS

Non-limiting and non-exhaustive embodiments are described with reference to the following figures in which:

FIG. 1 is an overhead view of a microelectronic pH sensor in accord with one embodiment of the present invention;

FIG. 2 is a cross-sectional view of the sensor of FIG. 1 illustrating the indicating electrode (IE);

FIG. 3 is a cross-sectional view of the reference electrode (RE) of FIG. 1;

FIG. 4 presents various options for a metal/metal oxide based reference electrode in accord with the present invention; and

FIG. 5A illustrates that an indicating electrode containing Ir/IrOx oxide layer without a conductive layer (“IrOx IE”) reads a voltage of 220 mV (FIG. 5A). This voltage refers to the specific redox couples introduced into the buffer solution at pH 10.

FIG. 5B illustrates that an indicating electrode containing IrOx metal/metal oxide layer with a protective polymeric film (“IrOX+mPDAB IE”) reads a voltage of 75 mV (FIG. 5B). This indicating electrode is sensitive at a pH of 10.

FIG. 6A illustrates that the IrOx+mPDAB IE provides distinct three point calibration measurements at pH 4.01, 7.00 and 10.01.

FIG. 6B illustrates that the measurements from FIG. 6A produce a linear calibration curve with an R² value of 1 (FIG. 6B).

FIG. 7 shows a bare IrOx indicating electrode was coupled with IrOx+mPDAB+Loctite RE or Ag/AgCl RE as well as the calibration measurements at 4.01, 7.00 and 10.01.

FIG. 8 shows a comparison of reference electrodes Au+Nafion+Loctite RE and Ag/AgCl glass electrode.

FIG. 9A shows a bare IrOx indicating electrode was coupled with Au+Nafion+Loctite RE or Ag/AgCl glass electrode and calibration measurements at 4.01, 7.00 and 10.01.

FIG. 9B shows a bare IrOx indicating electrode was coupled with Au+Nafion+Loctite RE or Ag/AgCl glass electrode and that these measurements produce linear calibration curves with R² values of 1.

FIG. 10 shows a comparison of reference electrode Au+mPDAB+Loctite RE and Ag/AgCl glass electrode.

FIG. 11A shows a bare IrOx indicating electrode was coupled with Au+mPDAB+Loctite RE or Ag/AgCl glass electrode and calibration measurements at 4.01, 7.00 and 10.01.

FIG. 11B shows a bare IrOx indicating electrode was coupled with Au+mPDAB+Loctite RE or Ag/AgCl glass electrode and that these measurements produce linear calibration curves with R² values of 0.994 and 0.9998, respectively.

In the drawings, like reference characters generally refer to corresponding parts throughout the different views. The drawings are not necessarily to scale, emphasis instead being placed on the principles and concepts of operation.

### DETAILED DESCRIPTION

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions that could be embodied in software, firmware or hardware, and when embodied in software, could be downloaded to reside on and be operated from different platforms used by a variety of operating systems.

The language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

Embodiments of the invention are directed to microelectronic pH sensors. These microelectronic pH sensors offer several functional advantages over prior art pH sensors: low cost, the ability to analyze smaller samples, faster analysis time, suitability for automated application, and increased reliability and repeatability.

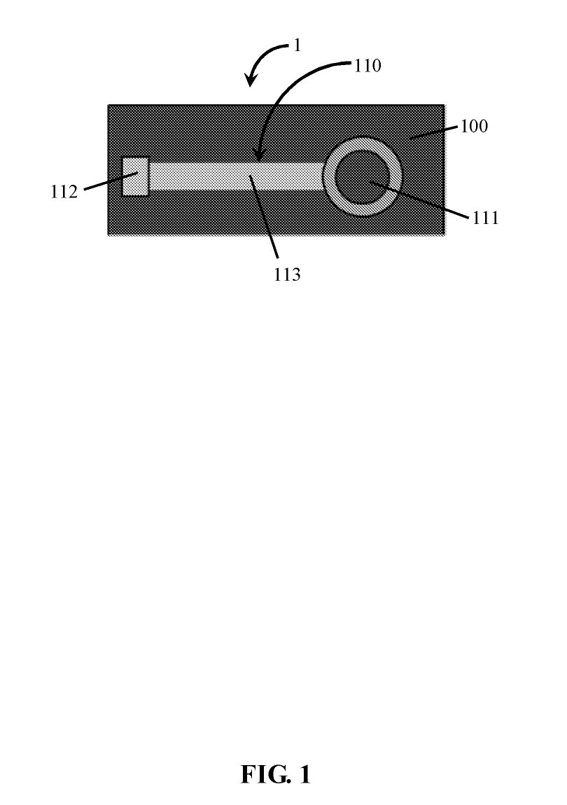

FIG. 1 is a schematic of a microelectronic pH sensor 1 of some embodiments of the invention. In such embodiments, the sensor may include an indicating electrode 110 disposed on a substrate 100. The indicating electrode 110 may include a sensing window 111 positioned to contact the material to be tested and an electrical contact 112 sized and positioned to connect to a pH reading device (not pictured) in spaced relationship to the sensing window 111. An electrode 113 may be disposed between the sensing window 111 and the electrical contact 112 to electrically connect the sensing window 111 to the electrical contact 112.

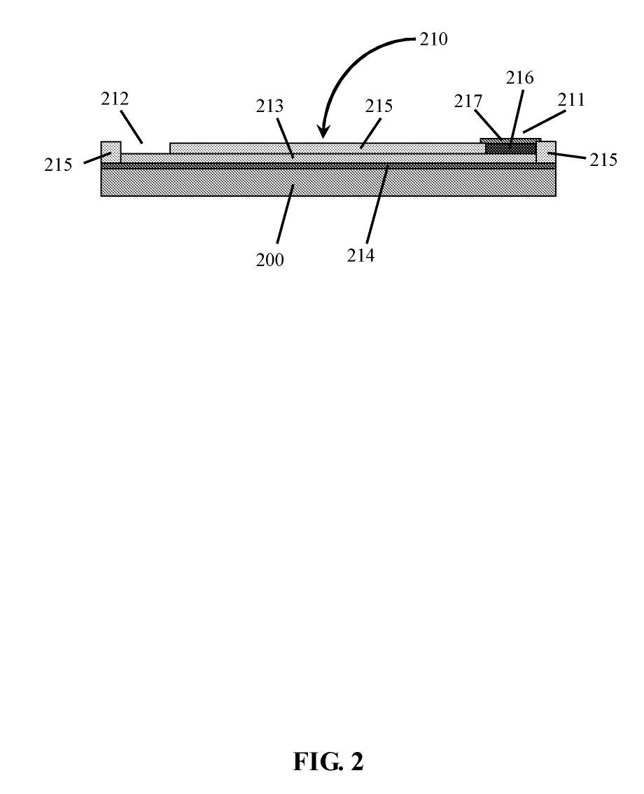

FIG. 2 is a cross-sectional view of the indicating electrode 110 of FIG. 1. The indicating electrode 210 illustrated in FIG. 2 may include a sensing window 211 and an electrical contact 212 connected by an electrode 213 disposed on a substrate 200. In various embodiments, the electrode 213 may be composed of a non-reactive, conductive metal such as, for example, gold, platinum, silver, aluminum, titanium, copper, chromium, and the like and combinations and alloys thereof. The electrode 213 may provide continuous electrical contact between the sensing window 211 and the electrical contact 212, and the electrode 213. A first passivation layer 214 may be disposed on the substrate 200 to insulate the electrode 213 and separate the electrode 213 from the substrate 200. A second passivation layer 215 may be disposed over the electrode 213 to insulate the electrode 213 from the external environment. The second passivation layer 215 may be disposed over the entire surface of the substrate 200 and openings may be provided at the sensing window 211 and the electrical contact 212 to allow the electrode 213 access to the external environment.

The sensing window 211 provides the active region of the indicating electrode 210. The sensing window 211 may include a reactive layer 216 disposed on and contacting the electrode 213. A conductive layer 217 may be disposed on the reactive layer 216 to shield the conductive layer 217 from the external environment and selectively allow passage of hydrogen ions (H⁺) through the conductive layer 217 to contact the reactive layer 216. The reactive layer 216 may be composed of a material that is sensitive to hydrogen ions (H⁺). For example, in various embodiments, the reactive layer 216 may be composed of metal/metal oxide. Examples of metal/metal oxide materials include iridium/iridium oxide, lead/lead oxide, rhodium/rhodium oxide, platinum/platinum oxide, and the like and combinations thereof. The electrical potential of such metal/metal oxides changes as a result of contact with hydrogen ions, This change in electrical potential may be transferred to the electrode 213 where it can be stored and/or transferred to a reading device through the electrical contact 212. The reading device can detect this change in potential and determine the pH of the material by comparing the potential change to controls.

The reactive layer 216 may be covered by a conductive layer 217, which selectively allows hydrogen ions to pass from the external environment to the reactive layer 216 while blocking other ionic species such as, for example, redox couples. The conductive layer 220 may be composed of any semi-permeable non-pH sensitive material known in the art, and examples such materials include, but are not limited to, polyphenols, polyanilines, poly(p-phenylene sulfide), polycarbazoles, polyindoles, and polythiophenes, perfluorosulfonic acid (PFSA)-based membranes, sulfonated polymer membranes, acid-base polymer complexes, and ionic liquid-based gel-type proton conducting membranes. Metal/metal oxides used in the reactive layer 216, such as those described above, can adsorb redox couples such as Fe²⁺/Fe³⁺, thiolate/disulfide, ascorbic acid/dehydroascorbic acid, which can block electron transfer, inhibiting the change in electrical potential created by contact with hydrogen ions and rendering the pH sensor insensitive to pH. The conductive layer 217 blocks such ionic species from contacting the reactive layer 216. The conductive layer 217 also isolates the reactive layer 216 from the external environment allowing the reactive layer 216 to maintain the electrical potential necessary for accurate pH measurements and improving the shelf-life of the microelectronic pH sensor as a whole. The thickness of the conductive layer 217 can vary among embodiments. For example, the conductive layer 220 may have a thickness of about 5 nanometers (nm) to about 20 nm.

Indicating electrodes 210 of various embodiments are extremely sensitive to changes in pH. Therefore, the size and shape of the sensing window 211 can vary among embodiments to provide a surface area for contacting analyte of at least about 3 square micrometers (μm²). Thus in some embodiments, the reactive layer 216 may have an exposed surface area of about 3 μm² to about 30 mm², about 4 μm² to about 20 mm², about 5 μm² to about 10 mm², any individual surface area or range encompassed by these example ranges. The size of the sensing window 211 may necessary to produce such surface areas may be from a diameter of about 1 micrometer (um) to about 10 millimeters (mm).

Passivation layers 214, 215 are used to protect and/or insulate electrode 213 and other components from damage or other adverse effects incurred from exposure to the external environment and material to the tested. The passivation layers 214, 215 also block electron transfer from materials outside the electrode 213 such as the substrate 200. Therefore, any non-pH sensitive, insulating material can be used in the passivation layers 214, 215. The first passivation layer 214 and the second passivation layer 215 may be composed of the same materials or different materials. Suitable materials for the passivation layers 214, 215 include, but are not limited to, silicon dioxide (SiO₂), silicon nitride (Si₃N₄), and the like, or the passivation layers can be composed of non-pH sensitive, impermeable polymers including for example, polyethylene, rubbers, and the like. In certain embodiments, the passivation layers 214, 215 may be composed of silicon nitride.

The substrate 200 may be composed of any material known in the art. For example, the substrate 200 may be a metal, metal alloy, or polymer material. In certain embodiments, the substrate 200 may be a semiconductor material such as, for example, silicon-based materials such as silicon, glass, silica nitride, silica carbide, and the like, non-silicon-based materials such as aluminum oxide, polymeric materials such as polydimethylsiloxane (PDMS) and the like and combinations thereof In some embodiments, the substrate 200 may be rigid and, in other embodiments, the substrate 200 may be flexible.

The indicating electrode 210 of various embodiments exhibit a wide pH response range, high sensitivity, fast response time, low potential drift, insensitivity to stirring, a wide temperature operating range, and a wide operating pressure range. Because of the small size of the indicating electrodes 210 of the invention, any number of indicating electrodes 210 may be disposed on the same substrate 200. For example, in various embodiments, the substrate 200 may have 1 to 100 individual indicating electrodes 210 disposed on its surface. In some embodiments, microelectronic pH meters including a substrate 200 having multiple indicating electrodes 210 disposed on their surfaces can be used to determine pH of a material overtime by delaying exposure of the reactive layer 216 to analyte using, for example, a removable cover or a degrading polymer overlay. In certain embodiments, the substrate 200 may further include one or more reference electrodes such as those describe below.

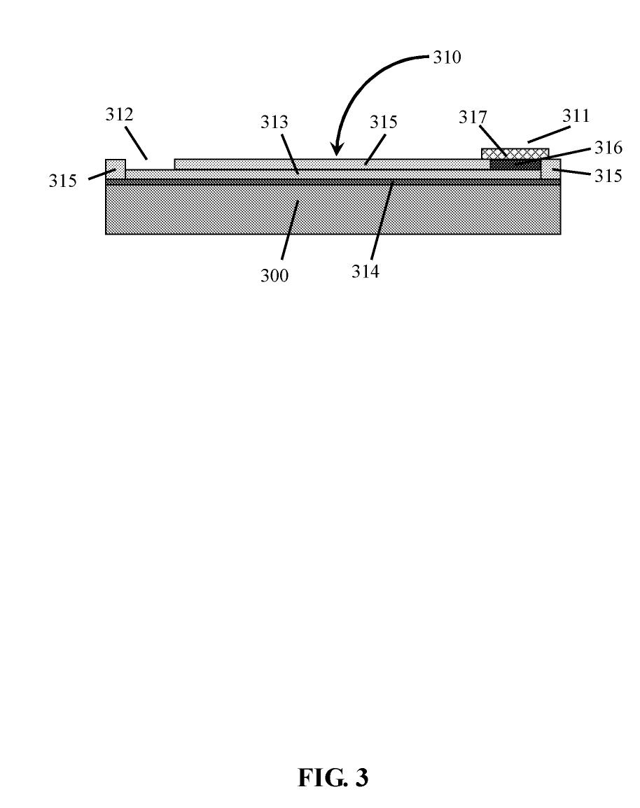

In some embodiments, the microelectronic pH sensors may further include a reference electrode. Although the configuration and type of reference electrode may vary among embodiments, the reference electrode, in some embodiments, may be composed of similar materials to the indicating electrodes 210 described above and illustrated in FIG. 1 and FIG. 2. For example, FIG. 3 is a schematic showing a cross-section view of a reference electrode 310 configured like the indicating electrodes 210 described above. Such reference electrodes 310 may include a sensing window 311 and an electrical contact 312 connected by an electrode 313 disposed on a substrate 300. A first passivation layer 314 may be disposed on the substrate 300, and a second passivation layer 315 may be disposed over the electrode to insulate the electrode from the external environment. The sensing window 311 may include a reactive layer 316 disposed on and contacting the electrode 313. In some embodiments, the reference electrode 310 may include an impermeable layer 317 disposed on the reactive layer 316. In other embodiments, the reference electrode 310 may include a conductive layer (not shown) disposed between the reactive layer 316 and the impermeable layer 317. In contrast to indicating electrodes, which allow hydrogen ions to pass while otherwise isolating the IE from analytes, the impermeable layer 317 of the reference electrode 310 provides a controlled environment having a constant H³⁰ or redox couples concentration. The impermeable layer 317 therefore maintains constant potential of the reference electrode 310 and completely isolates the reactive layer 316 of the reference electrode 310 from the external environment. The impermeable layer 317 may be composed of, for example, polytetrafluoroethylene, polyurethane, polyester, polyacrylate, polycyanoacrylate, plasticized polyvinyl chloride, and the like and combinations thereof, and in some embodiments, the impermeable layer 320 may be composed of a conductive layer material as described above that has been rendered impermeable by, for example, increasing the thickness of the conductive layer.

In some embodiments, the reference electrode 310 may include a buffering ligand, hydrogel, and other component that further controls the environment surrounding the reactive layer 316 incorporated into or substituting for the conductive layer disposed between the reactive layer 316 and the impermeable layer 320. The reference electrode 310 can be configured in various ways. For example, in some embodiments, a hydrogel or polymer containing a buffering ligand may be disposed between the reactive layer 316 and the impermeable layer 320. Examples of suitable hydrogels include poly(2-hydroxyethylmethacrylate), poly(N-isopropylacrylamide), poly(ethylene oxide), poly(dimethyl siloxane), and the like and combinations thereof, and examples of suitable polymers include polyphenol, polyaniline, polythiophene, poly(p-phenylene sulfide), polycarbazole, polyindole, and the like and derivatives thereof. In other embodiments, an electrolyte membrane such as a PFSA-based membrane may be disposed between the reactive layer 316 and the impermeable layer, and in certain embodiments, the electrolyte membrane may be modified with surfactants. In still other embodiments, a buffer solution or gel may be encapsulated by the impermeable layer 320 such that the buffer solution or gel is exposed to the reactive layer 316, and in some embodiments, the encapsulated buffer solution or gel may be saturated with redox species. Such encapsulated buffer solutions or gels can be used alone or in combination with a hydrogel, polymer, electrolyte membrane, or combinations thereof, and in some embodiments, these components may be modified with surfactants.

The general design of the reference electrode 310 can include the layers and materials shown in TABLE 1.

TABLE 1

| Layer | Materials |
|---|---|
| Metal | IrOx, RhOx, PtOx |
| Protective polymer | Polytetrafluoroethylene |
| | Polyurethane |
| | Polyester |
| | Polyacrylate |
| | Polycyanoacrylate |
| | Plasticized polyvinyl chloride |
| Polymer | Polyphenol and derivatives |
| | Polyaniline and derivatives |
| | Polythiophene and derivatives |
| | Poly(p-phenylene sulfide) and derivatives |
| | Polycarbazole and derivatives |
| | Polyindole and derivatives |
| Electrolyte membrane | PFSA-based membrane (Aciplex, Flemion, |
| | Nafion) |
| Hydrogel | Poly (2-hydroxyethylmethacrylate) |
| | Poly(N-isopropylacrylamide) |
| | Poly(ethylene oxide) |
| | Poly(dimethyl siloxane) |

Certain embodiments are directed to microelectronic pH sensors containing both indicating electrodes 210 and reference electrodes 310, and in some embodiments, the components of the reference electrode 310 may be composed of the same materials used in a corresponding indicating electrode 210. For example, embodiments of microelectronic pH sensors include sensors that include an indicating electrode 210 such as those described above in reference to FIG. 1 and FIG. 2 and a reference electrode 310 such as those described above in reference to FIG. 3. In such embodiments, the electrode, substrate 300, first passivation layer 214, a second passivation layer 215, and reactive layer may be composed of the same materials in the indicating electrode 210 and the reference electrode 310. In other embodiments, different materials may be used for each of these components of the indicating 210 and reference 310 electrodes.

Embodiments of the present invention are suited to a variety of commercial applications. For example, long-lived microelectronic pH sensors utilizing protective polymeric films may be used for near continuous pH monitoring in environmental and municipal water analysis, food processing, “in vivo” and “in vitro” biological fluid analysis, consumer product water analysis and pH control (e.g., swimming pools, hot tubs).

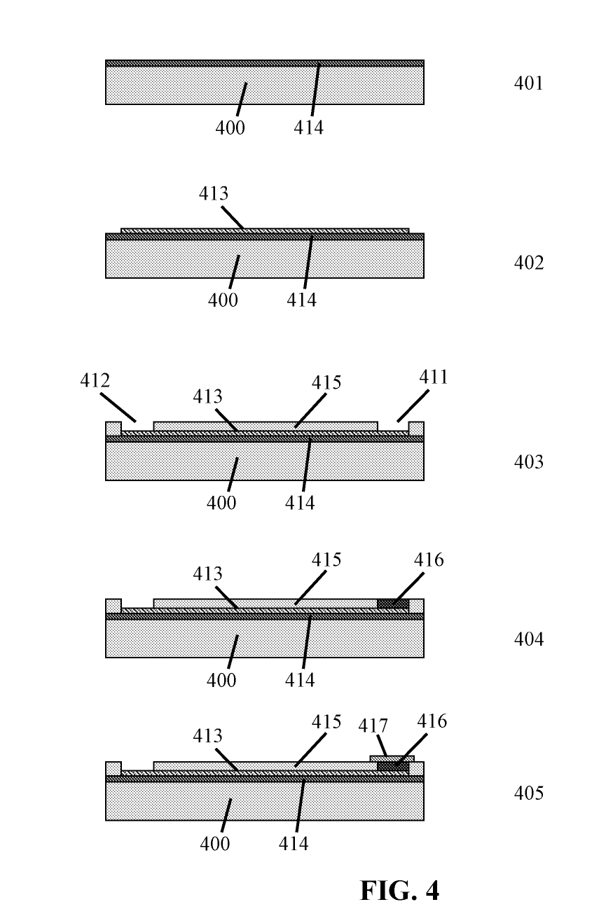

Further embodiments are directed to methods for making the microelectronic pH sensors described above. One example of such a method is illustrated in the diagram of FIG. 4. Such methods may include the step of applying 401 a first passivation layer 414 to a substrate 400, depositing 402 an electrode 413 on the first passivation layer 414, applying 403 a second passivation layer 415 over the electrode 413 leaving at least a sensing window 411 and an electric contact 412 exposed, depositing 404 a reactive layer 416 on the sensing window 411, and depositing 405 a conductive layer 417 on the reactive layer 416.

In some embodiments, depositing the conductive layer 417 on the reactive layer 416 may be carried out by electropolymerizing the conductive polymer on the reactive layer. Electropolymerizing can be carried out by immersing the microelectronic pH sensor in a solution containing monomeric units of the conductive polymer and applying a charge to the electrode. In some embodiments, the charge may be applied using a scanning cyclic voltammetry, and in particular embodiments, the cyclic scan can provide a potential of about 0.2 volts (V) to about 0.7 V versus a standard calomel electrode (SCE) at 1 mV/s.

In certain embodiments, the method may include the step of activating the surface of the reactive layer 416 before electropolymerizing. Activating the surface can be carried out by any method. For example, in some embodiments, activating the surface can be carried out by applying a charge to the electrode in an electrolyte solution such as phosphate buffer saline (PBS). In certain embodiments, the charge can be applied using scanning cyclic voltammetry, carried out, for example, at a voltage of about −0.5 V to about 1.0 V at 50 mV/second. The step of activating the surface may improve binding between the reactive layer 416 and the conductive layer 417, thereby improving the performance of the microelectronic pH meter.

The various layers described in the methods above can be applied or deposited in any manner. For example, in certain embodiments, the passivation layers 414, 415 can be applied by, for example, sputter coating, and the electrode and the trace may be applied by, for example, masking and sputter coating. The sensing window 411 and an electric contact 412 can be exposed using various masking or etching techniques, and depositing the reactive layer 416 can be carried out using, for example, magnetron sputtering. Although electropolymerizing is provided as an example method for applying the conductive layer, various other techniques including, for example, megnetron sputtering can be used in some embodiments.

The description and illustration of one or more embodiments provided in this application are not intended to limit or restrict the scope of the present disclosure as claimed in any way. The embodiments, examples, and details provided in this application are considered sufficient to convey possession and enable others to make and use the best mode of the claimed embodiments. The claimed embodiments should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed embodiments.

Various non-limiting example embodiments are listed below:

1. An indicating electrode for a pH sensor comprising:
a substrate;
an electrode disposed on the substrate;
a reactive layer disposed on a portion of the electrode; and
a conductive layer disposed on the reactive material.
   2. The indicating electrode of claim 1, wherein the reactive layer comprises a metal/metal oxide selected from the group consisting of iridium/iridium oxide, lead/lead oxide, rhodium/rhodium oxide, and platinum/platinum oxide.
   3. The indicating electrode of claim 1, wherein the conductive layer comprises a material selected from the group consisting of polyphenols, polyanilines, poly(p-phenylene sulfide), polycarbazoles, polyindoles, polythiophenes, perfluorosulfonic acid (PFSA) membranes, sulfonated polymer membranes, acid-base polymer complexes, and ionic liquid-based gel-type proton conducting membranes.
   4. The indicating electrode of claim 1, wherein the substrate is composed of a semiconductor material.
   5. The indicating electrode of claim 1, wherein the electrode is composed of a material selected from the group consisting of gold, platinum, silver, aluminum, titanium, copper, and chromium.
   6. The indicating electrode of claim 1, further comprising a first passivation layer disposed between the substrate and the electrode, a second passivation layer disposed on the electrode, and combinations thereof
   7. The indicating electrode sensor of claim 1, further comprising an electrical contact contacting the electrode and spaced from the reactive layer.
   8. A reference electrode for a pH sensor comprising:
a substrate;
an electrode disposed on the substrate;
a reactive layer disposed on a portion of the electrode; and
an impermeable layer disposed on the reactive material.
   9. The reference electrode of claim 8, wherein the reactive layer comprises a metal/metal oxide selected from the group consisting of iridium/iridium oxide, lead/lead oxide, rhodium/rhodium oxide, and platinum/platinum oxide.
   10. The reference electrode of claim 8, wherein the electrode is composed of a material selected from the group consisting of gold, platinum, silver, aluminum, titanium, copper, and chromium.
   11. The reference electrode of claim 8, wherein the substrate is composed of a semiconductor material.
   12. The microelectronic pH sensor of claim 8, further comprising a first passivation layer disposed between the substrate and the electrode, a second passivation layer disposed on the electrode, and combinations thereof.
   13. The reference electrode of claim 8, further comprising an electrical contact contacting the electrode and spaced from the reactive layer.
   15. The reference electrode of claim 8, wherein the impermeable layer comprises a material selected from the group of polytetrafluoroethylene, polyurethane, polyester, polyacrylate, polycyanoacrylate, and polyvinyl chloride.
   16. The reference electrode of claim 8, further comprising a conductive layer between the reactive layer and the impermeable layer.
   17. The reference electrode of claim 16, wherein the conductive layer is selected from the group consisting of a hydrogel, a conducting polymer, or an electrolyte membrane.
   18. The reference electrode of claim 16, wherein the conductive layer further comprises an encapsulated buffering ligand, buffer solution or buffer gel.
   19. The reference electrode of claim 16, wherein the conductive layer is saturated with redox species.
   20. The reference electrode of claim 16, wherein the conductive layer is modified with surfactants.
   21. A method for making a pH sensor comprising:
applying a first passivation layer to a substrate;
depositing an electrode on the first passivation layer;
applying a second passivation layer over the electrode leaving at least a sensing window
and an electric contact exposed;
depositing a reactive layer on the sensing window; and
depositing a conductive layer on the reactive layer.

### EXAMPLES

### Example 1

A microelectronic pH-sensitive indicating electrode was made on a silicon substrate with silicon dioxide (SiO2) passivation layers surrounding a gold electrode. An iridium/iridium oxide (Ir/IrOx) reactive layer was deposited at the sensing window. Sensors were created with and without a conductive layer composed of polydiaminobenzene electropolymerized onto the Ir/IrOx layer.

Electropolymerization was carried out as follows: An Ir/IrOx film was deposited on the Au electrode pad using a magnetron sputtering technique. The Ir/IrOx electrode surface was activated by five consecutive cyclic scans of potential between −0.5 V and 1.0 V at 50 mV/sec in the supporting phosphate buffer saline (PBS) electrolyte solution. The conductive layer electropolymerized in a stirred solution of 1,3-diaminobenzene (mDAB) (0.1-0.5 mM) in PBS. The electrolytic solution was deaerated with an argon gas before electrolysis for 20 min. The polymer film is formed by a single cyclic scan of potential between 0.2 V and 0.7 V versus standard calomel electrode (SCE) at 1 mV/s. A platinum wire is used as an auxiliary electrode. After electrochemical polymerization the chip is rinsed with DI water and then conditioned in buffer overnight.

### Example 2

Two pH-sensitive indicating electrodes were paired with a Ag/AgCl reference electrode. One of the electrodes was containing a bare Ir/IrOx layer, and another was fabricated as described in Example 1. Both pairs were exposed to a buffer solution pH 10 containing Fe²⁺/Fe³⁺ redox couple. Such solution is known to produce a constant voltage of 220 mV. The potential of each couple was measured using a standard potentiometric equipment.

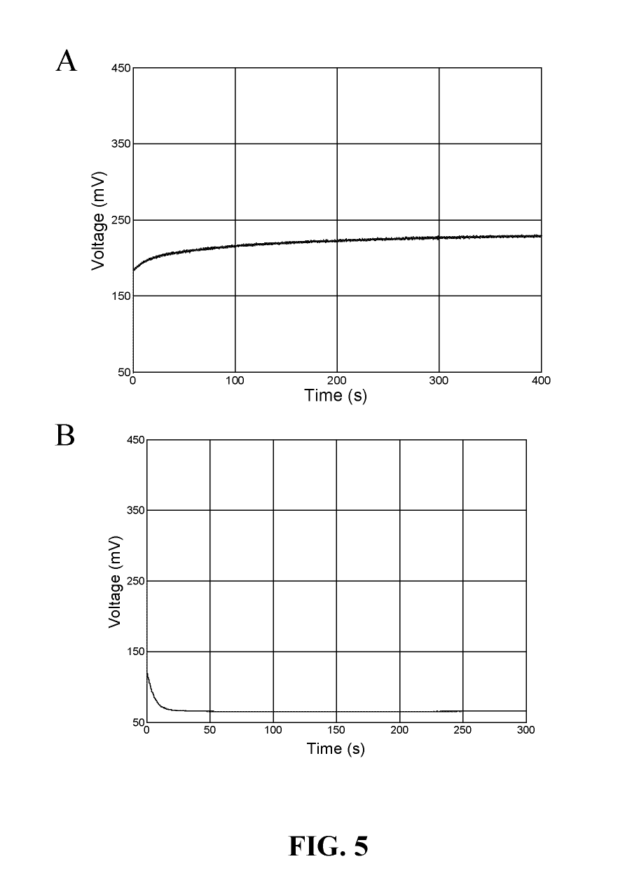

An indicating electrode containing Ir/IrOx oxide layer without a conductive layer (“IrOx IE”) reads a voltage of 220 mV (FIG. 5A). This voltage refers to the specific redox couples introduced into the buffer solution at pH 10.

An indicating electrode containing IrOx metal/metal oxide layer with a protective polymeric film (“IrOX+mPDAB IE”) reads a voltage of 75 mV (FIG. 5B). This indicating electrode is sensitive at a pH of 10. This experiment proves that a conductive layer prevents electron transfer blockage with redox active species on a reactive surface, thus, maintaining pH sensitivity of a microelectronic pH sensor.

### Example 3

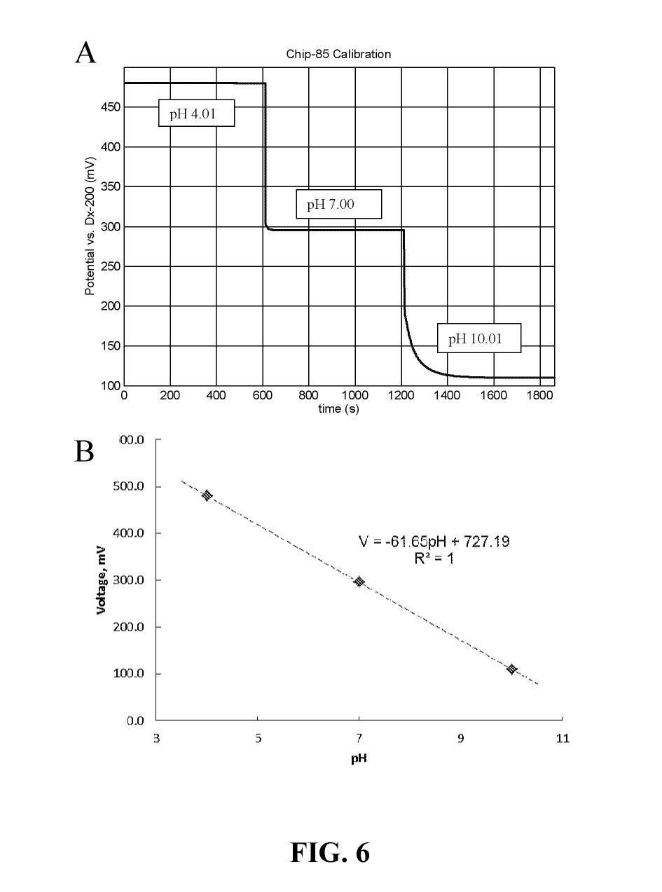

The IrOx+mPDAB IE provides distinct three point calibration measurements at pH 4.01, 7.00 and 10.01 (FIG. 6A). These measurements produce a linear calibration curve with an R² value of 1 (FIG. 6B).

### Example 4

The IrOx+mPDAB IE was used to measure the pH of household substances, and the same compositions were measured using a common, prior art, glass electrode results shown in TABLE 2.

TABLE 2
pH of household substances

| | glass | IrOx + mPDAB IE | |
|---|---|---|---|
| | electrode (pH) | (pH) | ΔpH |
| Multivitamin (Actilife) | 4.29 | 4.40 | 0.11 |
| Soy sauce (Kikkoman) | 4.69 | 4.70 | 0.01 |
| Beer (Miller Lite) | 3.96 | 4.01 | 0.05 |
| Vinegar (Migros) | 2.40 | 2.51 | 0.11 |
| Ketchup (Heinz) | 3.42 | 3.49 | 0.07 |
| Apple juice (Great Value) | 3.72 | 3.75 | 0.03 |
| Lemon juice (fresh) | 2.37 | 2.34 | −0.03 |
| Blueberry juice (fresh) | 3.37 | 3.33 | −0.04 |
| Tomato soup (Campbell's) | 4.24 | 4.30 | 0.06 |
| Egg white (Crystal Farms) | 8.93 | 9.03 | 0.10 |
| Hair conditioner (Migros) | 2.93 | 2.95 | 0.02 |
| Mouthwash (Top Care) | 4.36 | 4.35 | 0.01 |
| Average Deviation Relative | | | 0.05 |
| to Glass Electrode | | | |

### Example 4

A reference electrode consisting of IrOx and mPDAB and Loctite® 401 (IrOx+mPDAB+Loctite RE) was prepared in the following manner. The electrode surface is activated by five consecutive cyclic scans of potential between −0.5 V and 1.0 V at 50 mV/sec in the PBS solution. The electrode is electropolymerized in a stirred solution of 1,3-diaminobenzene (50 mM aqueous solution) in presence of 1 M 3-(N-morpholino)propanesulfonic acid buffer (MOPS). The electrode is then spin coated with Loctite ® 401, dried for 20 min, then stored in a buffer solution at pH 7.0 for 2 days.

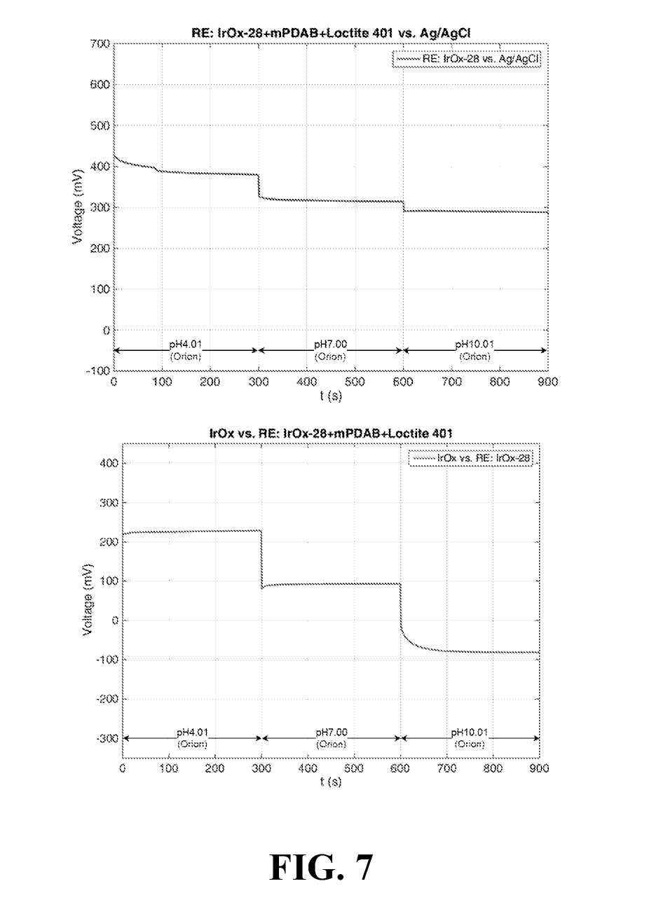

A bare IrOx indicating electrode was coupled with IrOx+mPDAB+Loctite RE or Ag/AgCl RE. The calibration measurements at 4.01, 7.00 and 10.01 are shown in FIG. 7.

### Example 5

A reference electrode consisting of Au and Nafion and Loctite (Au+Nafion+Loctite RE) was prepared in the following manner. The electrode was spin coated with Nafion solution and cured at 210° C. for 30 min. The electrode was spin coated with Loctite® 401, let dry for 20 min, then conditioned in a solution containing 0.1 M 2-chloroacetamide and 20 mM of Fe²⁺/Fe³⁺ for 2 days.

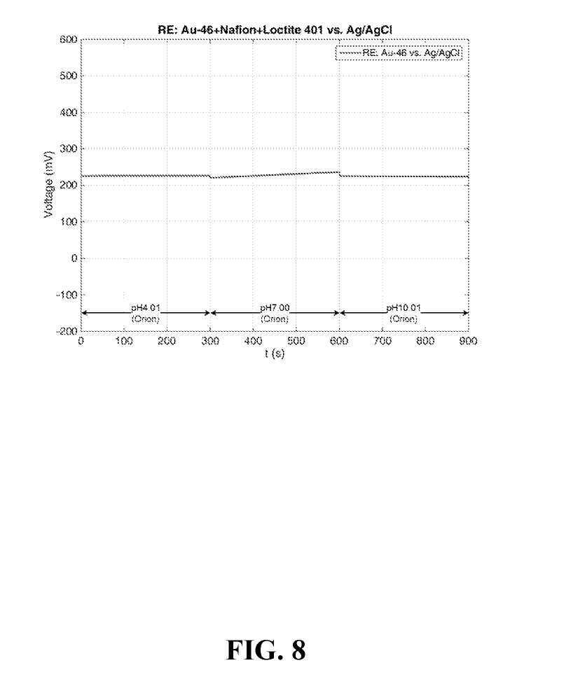

Reference electrodes Au+Nafion+Loctite RE and Ag/AgCl glass electrode are compared in FIG. 8.

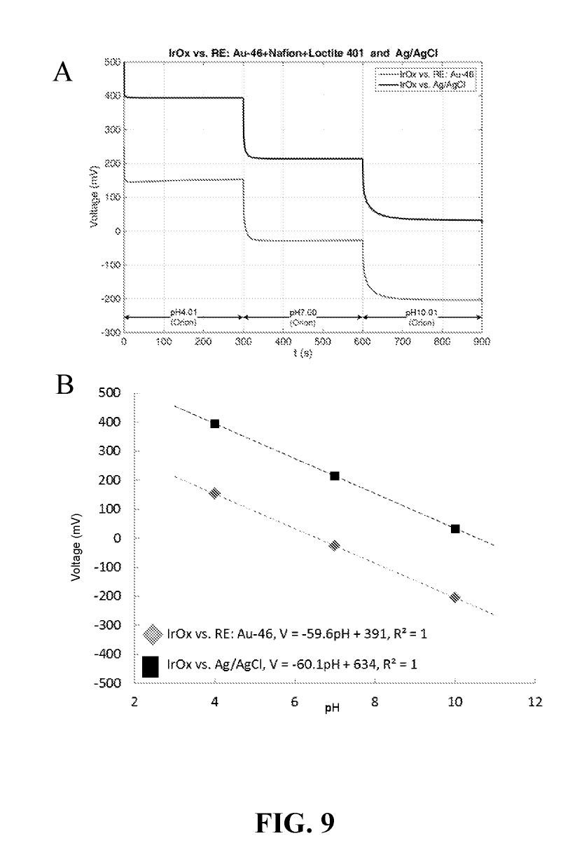

A bare IrOx indicating electrode was coupled with Au+Nafion+Loctite RE or Ag/AgCl glass electrode. The calibration measurements at 4.01, 7.00 and 10.01 are shown in FIG. 9A. These measurements produce linear calibration curves with R² values of 1 (FIG. 9B).

### Example 6

The reference electrode consisting of Au and mPDAB and Loctite® (Au+mPDAB+Loctite RE) was prepared in the following manner. The electrode surface was activated by five consecutive cyclic scans of potential between −0.5 V and 1.0 V at 50 mV/sec in the PBS solution. The electrode was electropolymerized in a stirred solution of 1,3 diaminobenzene (50 mM aqueous solution) in the PBS solution. The electrode was then spin coated with Loctite® 401, let dry for 20 min, then conditioned in 1 M KCl for three days.

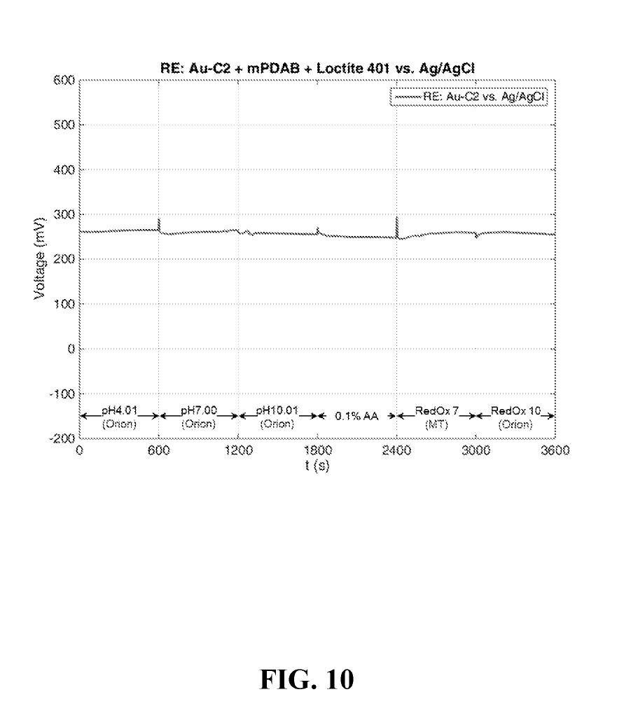

Reference electrode Au+mPDAB+Loctite RE and Ag/AgCl glass electrode are compared in FIG. 10.

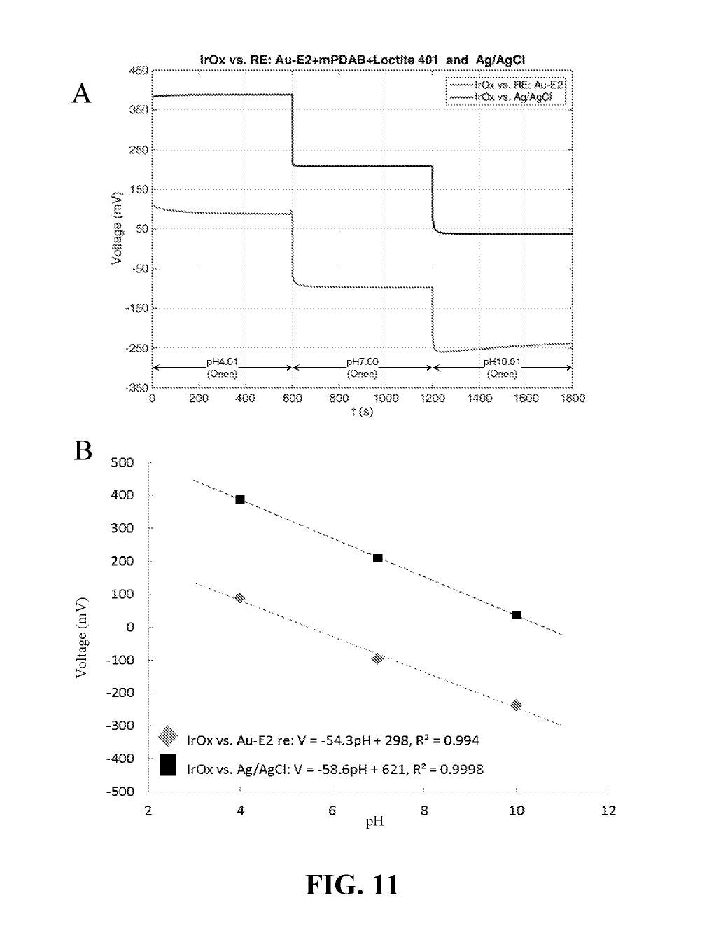

A bare IrOx indicating electrode was coupled with Au+mPDAB+Loctite RE or Ag/AgCl glass electrode. The calibration measurements at 4.01, 7.00 and 10.01 are shown in FIG. 11A. These measurements produce linear calibration curves with R² values of 0.994 and 0.9998, respectively (FIG. 11B).

1. An indicating electrode for a pH sensor comprising:
a substrate;
an electrode disposed on the substrate;
a reactive layer disposed on a portion of the electrode; and
a conductive layer disposed on the reactive material.

2. The indicating electrode of claim 1, wherein the reactive layer comprises a metal/metal oxide selected from the group consisting of iridium/iridium oxide, lead/lead oxide, rhodium/rhodium oxide, and platinum/platinum oxide.

3. The indicating electrode of claim 1, wherein the conductive layer comprises a material selected from the group consisting of polyphenols, polyanilines, poly(p-phenylene sulfide), polycarbazoles, polyindoles, polythiophenes, perfluorosulfonic acid (PFSA) membranes, sulfonated polymer membranes, acid-base polymer complexes, and ionic liquid-based gel-type proton conducting membranes.

4. The indicating electrode of claim 1, wherein the substrate is composed of a semiconductor material.

5. The indicating electrode of claim 1, wherein the electrode is composed of a material selected from the group consisting of gold, platinum, silver, aluminum, titanium, copper, and chromium.

6. The indicating electrode of claim 1, further comprising a first passivation layer disposed between the substrate and the electrode, a second passivation layer disposed on the electrode, and combinations thereof

7. The indicating electrode sensor of claim 1, further comprising an electrical contact contacting the electrode and spaced from the reactive layer.

8. A reference electrode for a pH sensor comprising:
a substrate;
an electrode disposed on the substrate;
a reactive layer disposed on a portion of the electrode; and
an impermeable layer disposed on the reactive material.

9. The reference electrode of claim 8, wherein the reactive layer comprises a metal/metal oxide selected from the group consisting of iridium/iridium oxide, lead/lead oxide, rhodium/rhodium oxide, and platinum/platinum oxide.

10. The reference electrode of claim 8, wherein the electrode is composed of a material selected from the group consisting of gold, platinum, silver, aluminum, titanium, copper, and chromium.

11. The reference electrode of claim 8, wherein the substrate is composed of a semiconductor material.

12. The microelectronic pH sensor of claim 8, further comprising a first passivation layer disposed between the substrate and the electrode, a second passivation layer disposed on the electrode, and combinations thereof.

13. The reference electrode of claim 8, further comprising an electrical contact contacting the electrode and spaced from the reactive layer.

15. The reference electrode of claim 8, wherein the impermeable layer comprises a material selected from the group of polytetrafluoroethylene, polyurethane, polyester, polyacrylate, polycyanoacrylate, and polyvinyl chloride.

16. The reference electrode of claim 8, further comprising a conductive layer between the reactive layer and the impermeable layer.

17. The reference electrode of claim 16, wherein the conductive layer is selected from the group consisting of a hydrogel, a conducting polymer, or an electrolyte membrane.

18. The reference electrode of claim 16, wherein the conductive layer further comprises an encapsulated buffering ligand, buffer solution or buffer gel.

19. The reference electrode of claim 16, wherein the conductive layer is saturated with redox species.

20. The reference electrode of claim 16, wherein the conductive layer is modified with surfactants.

21. A method for making a pH sensor comprising:
applying a first passivation layer to a substrate;
depositing an electrode on the first passivation layer;
applying a second passivation layer over the electrode leaving at least a sensing window and an electric contact exposed;
depositing a reactive layer on the sensing window; and
depositing a conductive layer on the reactive layer.
